(19) United States
(12) Patent Application Publication
(10) Pub. No.: US 2019/0266854 A1
(43) Pub. Date: Aug. 29, 2019

(54) AUTOMATED TELLER MACHINE WITH RETRACTABLE FASCIA AND SHUTTER

(71) Applicant: NCR Corporation, Duluth, GA (US)

(72) Inventors: Ian McFarlane Denny, Perth (GB); Marshall Munro, Dunfermline (GB); Steve Swaine, Perth (GB)

(21) Appl. No.: 15/907,081

(22) Filed: Feb. 27, 2018

(51) Int. Cl. G07F 19/00

(52) U.S. Cl. CPC G07F 19/205

(57) ABSTRACT

An automated teller machine (ATM) can be mounted in a wall. A sleeve can attach to the wall to prevent access between a consumer side of the wall and a service side of the wall. A fascia can be repositioned between an engaged position and a retracted position. The fascia can be accessed from the consumer side of the wall through an aperture in the sleeve when the fascia is in the engaged position. The fascia can be positioned on the service side of the wall when the fascia is in the retracted position. A shutter can automatically cover the aperture in the sleeve when the fascia moves to the retracted position. The shutter can provide added security when a service person is servicing the ATM. Because the service person can access the fascia, the ATM can advantageously omit redundant display or input components accessible only to the service side.

### TECHNICAL FIELD

The present disclosure relates to a through-the-wall automated teller machine (ATM).

### BACKGROUND

When a service person services a through-the-wall automated teller machine on a street, the service person and the machine can be vulnerable to attack.

### SUMMARY

In a first example, an automated teller machine can be mounted in a wall. A sleeve can be attached to the wall to prevent access between a consumer side of the wall and a service side of the wall opposite the consumer side. A fascia can be repositioned between an engaged position and a retracted position. The fascia can be accessible to the consumer side of the wall through an aperture in the sleeve when the fascia is in the engaged position. The fascia can be positioned on the service side of the wall when the fascia is in the retracted position. A shutter can automatically cover the aperture in the sleeve when the fascia moves to the retracted position.

In a second example, a method can service an automated teller machine mounted in a wall. The automated teller machine can be accessed from a service side of the wall. The automated teller machine can include a sleeve attached to the wall. The sleeve can prevent access between the service side of the wall and a consumer side of the wall opposite the service side. A fascia can be moved from an engaged position to a retracted position. The fascia can be accessible to the consumer side of the wall through an aperture in the sleeve when the fascia is in the engaged position. The fascia can be positioned on the service side of the wall when the fascia is in the retracted position. A shutter can automatically cover the aperture in the sleeve when the fascia moves to the retracted position.

In a third example, an automated teller machine can be mounted in a vertical wall. A sleeve attachable to the wall can prevent access between a consumer side of the wall and a service side of the wall opposite the consumer side. A fascia can be repositionable along a horizontal path between an engaged position and a retracted position. The fascia can be accessible to the consumer side of the wall through a rectangular aperture in the sleeve when the fascia is in the engaged position. The fascia can be positioned on the service side of the wall when the fascia is in the retracted position. A shutter can automatically cover the aperture in the sleeve when the fascia moves to the retracted position. An actuator can selectively move the shutter. A controller can selectively power the actuator. A pair of ratchets positioned on opposing sides of the rectangular aperture can prevent reverse motion of the shutter when the shutter moves to cover the aperture.

### BRIEF DESCRIPTION OF THE DRAWINGS

The present disclosure is illustrated by way of example and not limitation in the figures of the accompanying drawings, in which like reference numbers indicate similar elements.

FIG. 1 shows a side view cross-section of an example of a through-the-wall automated teller machine (ATM) during normal operation, with a fascia positioned in an engaged position, in accordance with some embodiments.

FIG. 2 shows a side view cross-section of an example of the through-the-wall automated teller machine of FIG. 1 during servicing, with a fascia and a cover both positioned in a retracted position, in accordance with some embodiments.

FIG. 3 shows a side view cross-section of an example of the through-the-wall automated teller machine of FIGS. 1 and 2 during servicing, with a fascia positioned in an engaged position and a cover positioned in a retracted position, in accordance with some embodiments.

FIG. 4 shows an example of a method for servicing an automated teller machine mounted in a wall, in accordance with some embodiments.

FIG. 5 shows a block diagram of an example of a controller, such as a through-the-wall automated teller machine, in accordance with some embodiments.

It should be noted that elements in the drawings are not necessarily drawn to scale. The configurations shown in the drawings are merely examples, and should not be construed as limiting in any manner.

### DETAILED DESCRIPTION

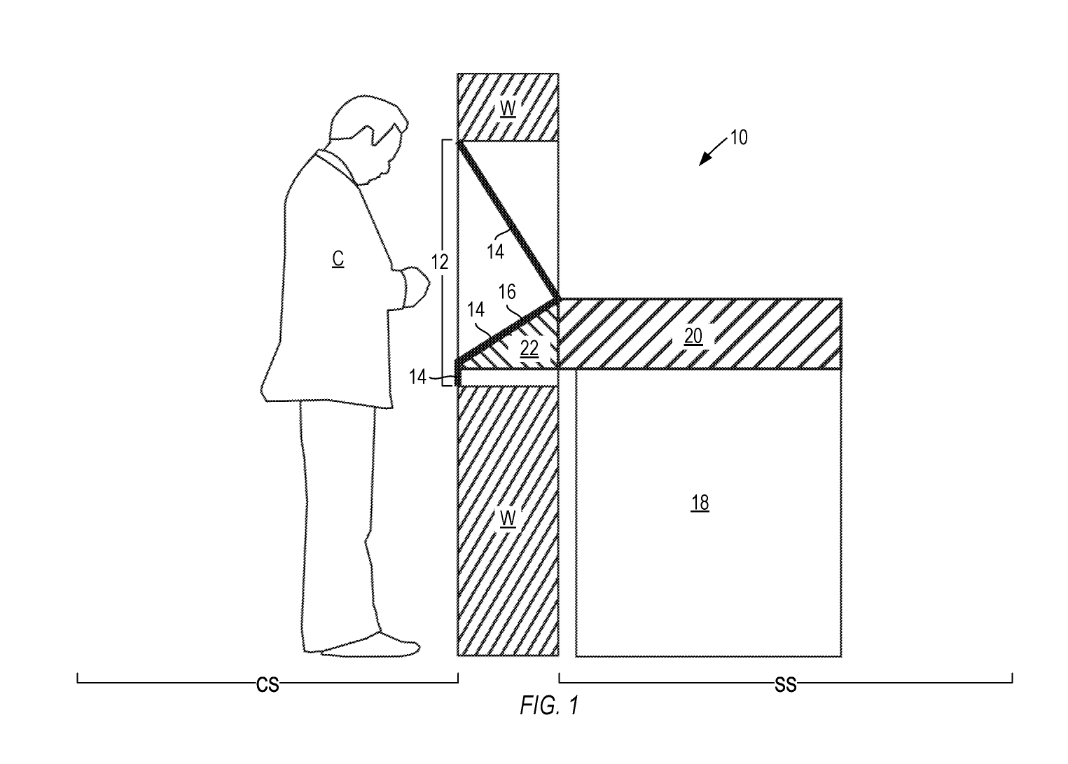

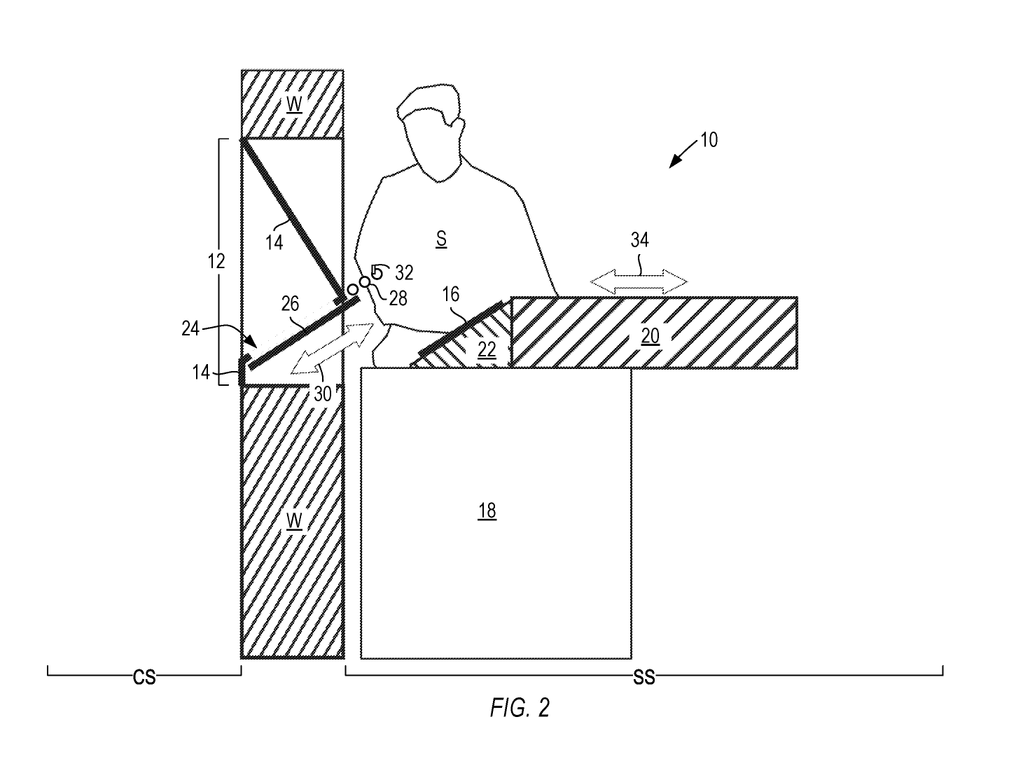

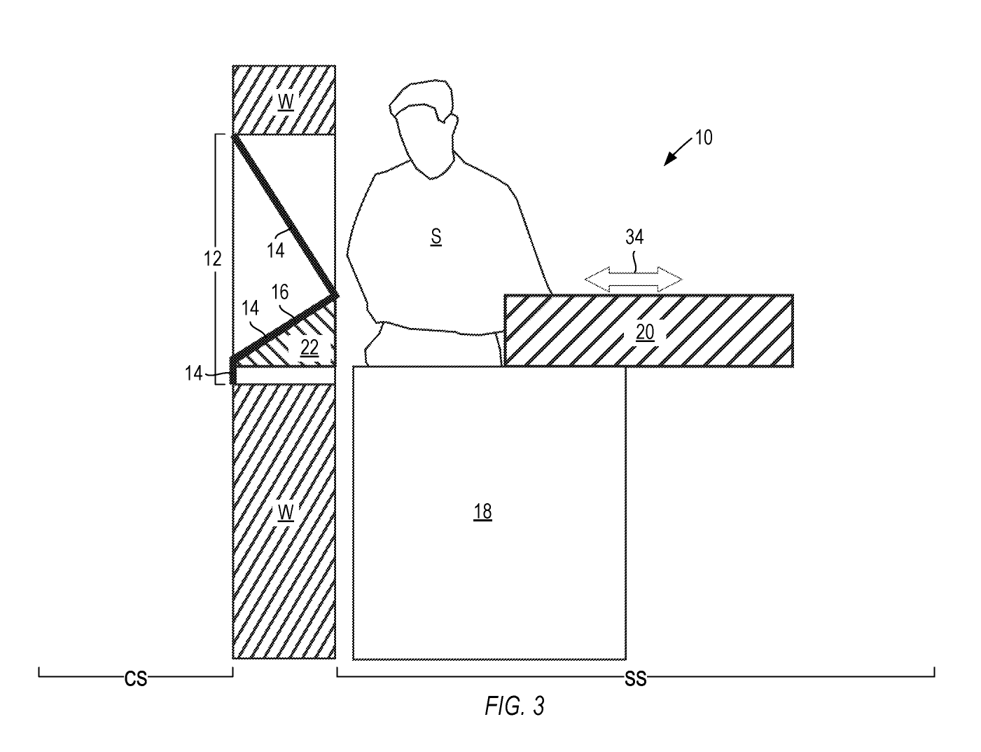

FIG. 1 shows a side view cross-section of an example of a through-the-wall automated teller machine (ATM) during normal operation, with a fascia positioned in an engaged position, in accordance with some embodiments. FIG. 2 shows a side view cross-section of an example of the through-the-wall automated teller machine of FIG. 1 during servicing, with a fascia and a cover both positioned in a retracted position, in accordance with some embodiments. FIG. 3 shows a side view cross-section of an example of the through-the-wall automated teller machine of FIG. 1 during servicing, with a fascia positioned in an engaged position and a cover positioned in a retracted position, in accordance with some embodiments. The ATM configuration of FIGS. 1-3 is but one example; other suitable configurations can also be used.

The ATM 10 can be mounted in a wall (W). On a consumer side (CS) of the wall (W), a consumer (C) can access the ATM 10 at an interface head 12 of the ATM 10. The interface head 12 can include all the ATM elements that can be accessed by the consumer (C); all other elements of the ATM 10 can be positioned behind the interface head 12, either within the wall (W) or on a service side (SS) of the wall (W) opposite the consumer side (CS).

The interface head 12 can include a sleeve 14. The sleeve 14 can be attached to the wall (W) to prevent access between the consumer side (CS) of the wall and the service side (SS) of the wall opposite the consumer side (CS).

A portion of the sleeve 14 can include a fascia 16. The fascia 16 can be repositionable between an engaged position (FIGS. 1 and 3) and a retracted position (FIG. 2). The fascia 16 can be accessible to the consumer side (CS) of the wall (W) through an aperture 24 in the sleeve 14 when the fascia 16 is in the engaged position (FIGS. 1 and 3). The fascia 16 can be positioned on the service side (SS) of the wall (W) when the fascia 16 is in the retracted position (FIG. 2).

The fascia 16 can include one or more display screens, one or more buttons, and/or one or more slots that can accommodate banknotes or credit or bank cards. In some examples, a top portion and a bottom portion of the sleeve 14 can extend above and below the fascia 16, respectively, and can optionally be flush with the wall (W).

During normal operation of the ATM 10, consumers approach and interact with elements on the fascia 16. The wall (W) prevents consumers from interacting with any ATM elements that are not on the fascia 16, such as a housing 18, a cover 20 positioned on a top of the housing 18, and a fascia interface 22 that can mechanically couple the fascia 16 to the cover 20.

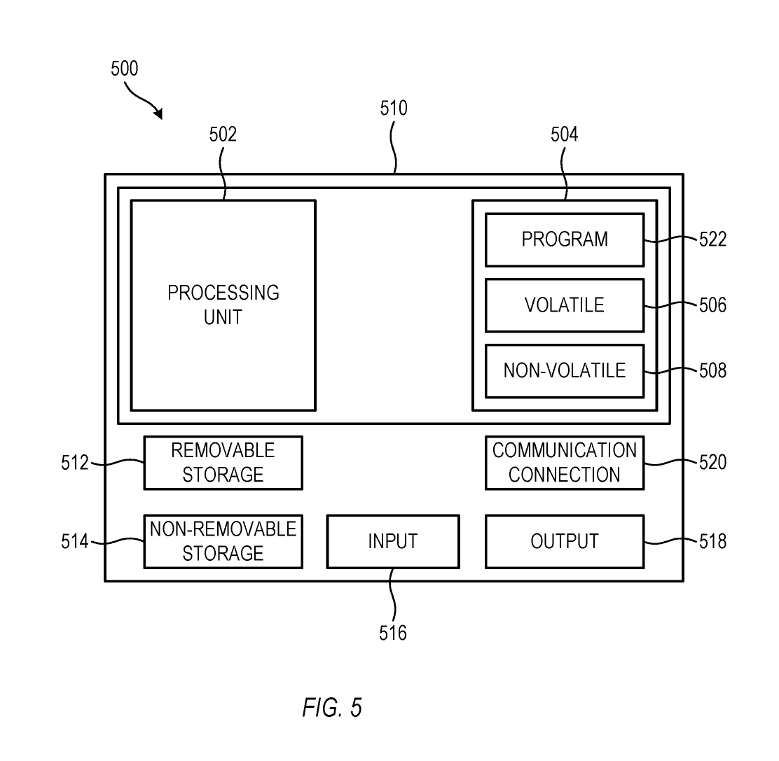

The housing 18 can include one or more compartments that can store banknotes or other materials, belts, rollers, or other transport mechanisms for the banknotes, and circuitry to receive input from the fascia 16, communicate with one or more network-connected servers external to the ATM 10, and direct output to a display on the fascia 16. Further detail regarding the circuitry is shown below in FIG. 5.

The cover 20 can provide access to an interior of the housing 18, so that a service person can empty banknotes and other deposited materials from the storage compartments, replenish banknotes as needed, fix jams, repair or maintain the belts, rollers, or other transport mechanisms as needed, and/or update the circuitry as needed. A service person can move or slide the cover 20 between a closed position proximate the wall (FIG. 1) and an open position away from the wall (FIGS. 2 and 3). During normal operation of the ATM 10, the cover 20 can remain in the closed position, as shown in FIG. 1, so that the cover 20 can seal all or a portion of the top of the ATM 10. During servicing of the ATM 10, the cover 20 can be in the open position, as shown in FIGS. 2 and 3.

The fascia interface 22 can include circuitry that can drive a display on the fascia 16, circuitry that can receive input from the consumer (C) on a touch-sensitive display and/or through one or more buttons on the fascia 16, and circuitry and mechanical elements that can direct banknotes from the housing 18 out through a slot in the fascia 16 and can receive deposited notes through the slot or an optional second slot in the fascia 16. The fascia interface 22 can removably couple the fascia 16 to the cover 20, so that the fascia 16 and cover 20 can be repositioned together. The fascia interface 22 can also detach the fascia 16 from the cover 20, so that the cover 20 can be repositioned without moving the fascia 16.

A shutter 26 can automatically cover the aperture 24 in the sleeve 14 when the fascia 16 moves to the retracted position (FIG. 2). In some examples, the wall (W) can be oriented vertically, and the fascia 16 can be movable along a horizontal path that is orthogonal to the wall (W). In some examples, when the fascia 16 is in the retracted position (FIG. 2), the fascia 16 can be accessible to a service person (S) on the service side (SS) of the wall (W).

An actuator 28 can selectively move the shutter 26. A controller (shown below in FIG. 5) can selectively power the actuator 28. In some examples, the controller can actuate the actuator 28 automatically upon sensing that the fascia 16 has been moved from the engaged position. The sensing can include a mechanical switch or trigger, an electrical switch or trigger, or another suitable sensing mechanism. A housing 18 positioned on the service side (SS) of the wall (W) can surround the controller. In some examples, the shutter 26 can translate along a path 30 that is parallel to the aperture 24 of the sleeve 14. In some examples, at least one ratchet 32 can prevent reverse motion of the shutter 26 when the shutter 26 moves to cover the aperture 24. In some examples, the aperture 24 and the shutter 26 are rectangular in shape. In some examples, the ATM includes a pair of ratchets 32 positioned on opposing sides of a rectangular aperture 24.

A cover 20 can be positioned on a top of the housing 18. In some examples, the cover 20 can removably couple to the fascia 16, via the fascia interface 22. In some examples, the cover 20 can be repositionable between a closed position (FIG. 1) proximate the wall (W) and an open position (FIGS. 2 and 3) away from the wall (W), such that the fascia 16 and the cover 20 are repositionable along a common path 34. In some examples, the cover 20 can seal a top of the housing 18 when the cover 20 is in the closed position. In some examples, an interior of the housing 18 can be accessible through the top of the housing 18 when the cover 20 is in the open position. In some examples, the cover 20 can include a banknote validator and storage for valid banknotes. In other examples, the cover 20 can include a printer that can print statements or receipts. In still other examples, the cover 20 can include a tray.

An advantage to the ATM 10 is that the ATM 10 need not be serviced from the consumer side (CS) of the wall (W). In contrast, for an ATM in which the fascia remains stationary, some procedures can require a service person (S) to be exposed on the consumer side (CS) of the wall (W), which can pose a security risk.

Another advantage to the ATM 10 is that the service person (S) has access to the banknote slot in the fascia 16, and can easily access the mechanical parts of the slot from both sides of the fascia 16. In contrast, for an ATM in which the fascia remains stationary, such a procedure can require two service people, one on either side of the wall.

Another advantage to the ATM 10 is that the shutter 26 automatically protects the aperture 24 in the sleeve 14, when the fascia 16 is retracted. As a result, the shutter 26 can prevent interference from passersby, which can increase security for the service person (S).

Another advantage to the ATM 10 is that the service person (S) can view instructions on the display on the fascia 16 during a service call. This would not be possible if the fascia 16 were fixed in place. In contrast, for ATMs in which the fascia does not move, there is typically a relatively low-quality video screen that is viewable only on the service side of the wall. The present ATM, with its retractable fascia, can therefore omit such a service-only video screen, resulting in cost savings and reduced complexity for the ATM.

Similarly, the service person (S) can provide input to the ATM through the fascia 16 during a service call. This would not be possible if the fascia 16 were fixed in place. In contrast, for ATMs in which the fascia does not move, there is typically a service operator panel that is accessible only on the service side of the wall. The present ATM, with its retractable fascia, can therefore omit such a service operator panel, resulting in cost savings and reduced complexity for the ATM.

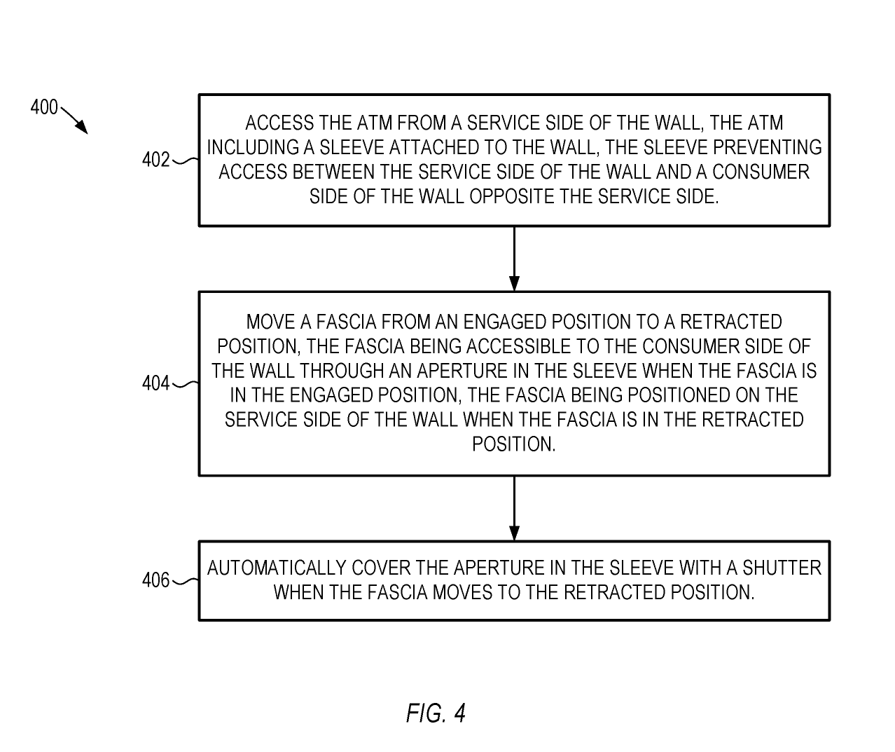

FIG. 4 shows an example of a method 400 for servicing an automated teller machine mounted in a wall, in accordance with some embodiments. The method can be executed on the ATM 10 of FIGS. 1-3, or by another suitable ATM. The method 400 is but one example; other suitable methods can also be used.

At operation 402, the automated teller machine can be accessed from a service side of the wall. The automated teller machine can include a sleeve attached to the wall. The sleeve can prevent access between the service side of the wall and a consumer side of the wall opposite the service side.

At operation 404, a fascia can be moved from an engaged position to a retracted position. The fascia can be accessible to the consumer side of the wall through an aperture in the sleeve when the fascia is in the engaged position. The fascia can be positioned on the service side of the wall when the fascia is in the retracted position.

At operation 406, the aperture in the sleeve can be automatically covered with a shutter when the fascia moves to the retracted position.

FIG. 5 shows a block diagram of an example of a controller 500, such as a through-the-wall automated teller machine, in accordance with some embodiments. The controller 500 can be part of a system that includes a sleeve, fascia, shutter, actuator, circuitry, optional ratchets, and other optional elements. The example of FIG. 5 is but one configuration for a controller; other configurations can also be used.

In one embodiment, multiple such controllers 500 are utilized in a distributed network to implement multiple components in a transaction based environment. An object-oriented, service-oriented, or other architecture may be used to implement such functions and communicate between the multiple controllers 500 and components.

One example of a controller 500, in the form of a computer 510, can include a processing unit 502, memory 504, removable storage 512, and non-removable storage 514. Memory 504 may include volatile memory 506 and non-volatile memory 508. Computer 510 may include, or have access to a computing environment that includes, a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) and electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a non-transitory computer-readable medium. For example, a computer program 522 with instructions for the computer 510, according to the teachings of the present disclosure, may be included on a CD-ROM and loaded from the CD-ROM to a hard drive. The computer-readable instructions allow computer 510 to provide generic access controls in a COM based computer network system having multiple users and servers.

What is claimed is:

1. An automated teller machine configured to be mounted in a wall, the automated teller machine comprising:
a sleeve attachable to the wall to prevent access between a consumer side of the wall and a service side of the wall opposite the consumer side;
a fascia repositionable between an engaged position and a retracted position, the fascia being accessible to the consumer side of the wall through an aperture in the sleeve when the fascia is in the engaged position, the fascia being positioned on the service side of the wall when the fascia is in the retracted position; and
a shutter configured to automatically cover the aperture in the sleeve when the fascia moves to the retracted position.

2. The device of claim 1, wherein:
the wall is oriented vertically; and
the fascia is movable along a horizontal path that is orthogonal to the wall.

3. The device of claim 2, wherein when the fascia is in the retracted position, the fascia is accessible to the service side of the wall.

4. The device of claim 1, further comprising an actuator configured to selectively move the shutter.

5. The device of claim 4, further comprising a controller configured to selectively power the actuator.

6. The device of claim 5, further comprising a housing positioned on the service side of the wall and surrounding the controller.

7. The device of claim 1, wherein the shutter is configured to translate along a path that is parallel to the aperture of the sleeve.

8. The device of claim 7, further comprising at least one ratchet configured to prevent reverse motion of the shutter when the shutter moves to cover the aperture.

9. The device of claim 8, wherein the aperture and the shutter are rectangular in shape.

10. The device of claim 9, wherein the at least one ratchet includes a pair of ratchets positioned on opposing sides of the rectangular aperture.

11. The device of claim 1, further comprising a cover that is:
positioned on a top of the housing,
removably couplable to the fascia, and
repositionable between a closed position proximate the wall and an open position away from the wall, such that the fascia and the cover are repositionable along a common path.

12. The device of claim 11, wherein:
the cover seals a top of the housing when the cover is in the closed position; and
an interior of the housing is accessible through the top of the housing when the cover is in the open position.

13. The device of claim 11, wherein the cover includes a banknote validator and storage for valid banknotes.

14. The device of claim 1, wherein the automated teller machine lacks a video screen that is viewable only on the service side of the wall.

15. The device of claim 1, wherein the automated teller machine lacks a service operator panel that is accessible only on the service side of the wall.

16. A method for servicing an automated teller machine mounted in a wall, the method comprising:
accessing the automated teller machine from a service side of the wall, the automated teller machine including a sleeve attached to the wall, the sleeve preventing access between the service side of the wall and a consumer side of the wall opposite the service side;
moving a fascia from an engaged position to a retracted position, the fascia being accessible to the consumer side of the wall through an aperture in the sleeve when the fascia is in the engaged position, the fascia being positioned on the service side of the wall when the fascia is in the retracted position; and
automatically covering the aperture in the sleeve with a shutter when the fascia moves to the retracted position.

17. The method of claim 16, further comprising:
sliding a cover, positioned on a top of a housing of the automated teller machine, from a closed position proximate the wall and an open position away from the wall.

18. The method of claim 17, wherein the fascia and the cover are coupled together and move along a common path.

19. An automated teller machine configured to be mounted in a vertical wall, the automated teller machine comprising:
a sleeve attachable to the wall to prevent access between a consumer side of the wall and a service side of the wall opposite the consumer side;
a fascia repositionable along a horizontal path between an engaged position and a retracted position, the fascia being accessible to the consumer side of the wall through a rectangular aperture in the sleeve when the fascia is in the engaged position, the fascia being positioned on the service side of the wall when the fascia is in the retracted position;
a shutter configured to automatically cover the aperture in the sleeve when the fascia moves to the retracted position;
an actuator configured to selectively move the shutter;
a controller configured to selectively power the actuator; and
a pair of ratchets positioned on opposing sides of the rectangular aperture and configured to prevent reverse motion of the shutter when the shutter moves to cover the aperture.

20. The automated teller machine of claim 19, further comprising a housing positioned on the service side of the wall and surrounding the controller.
